(19) United States
(12) Patent Application Publication
(10) Pub. No.: US 2008/0160920 A1
(43) Pub. Date: Jul. 3, 2008

(54) Device for reducing wireless interference

(76) Inventors: Ernest T. Tsui, Cupertino, CA (US); Setul Shah, Folsom, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/647,940

(22) Filed: Dec. 28, 2006

(51) Int. Cl. H04B 17/00

(52) U.S. Cl. 455/67.13

(57) ABSTRACT

A method, apparatus, and system in which a receiver circuit includes an RF power detector, a suppression filter having a band rejection frequency range targeted to suppress interference between a transmitter and the receiver circuit when enabled, and a filter logic to enable and disable the suppression filter while the device is in operation based on a signal strength of a received RF signal. Other embodiments are described.

### FIELD OF THE INVENTION

Some embodiments of the invention generally relate to wireless devices. More particularly, an aspect of an embodiment of the invention relates to a method and apparatus for reducing wireless interference.

### BACKGROUND OF THE INVENTION

There exists a plethora of wireless broadcast and communication protocols, many of them operating in regulated frequency bands and some of them operating in unregulated frequency bands. Many mobile devices, such as cellular phones, notebook computers, personal data assistants (PDAs), etc., use at least one of these communication and broadcast protocols to send and/or receive data. When a mobile device receives data using one communication or broadcast protocol, it may experience interference due to signals from other communication protocols that operate at nearby frequency bands and are sufficiently close to the other receiver antenna. This interference can saturate a receiver and result in distortions and harmonics that might cause interference to signals of interest.

Some receivers mitigate interference by filtering the received signal. This can cause a loss of sensitivity for the receivers, for example, due to accompanying insertion loss of the filter, and can result in loss of signal reception.

Since modern mobile devices frequently incorporate multiple different communication protocols. Data may be concurrently transmitted and/or received under these different wireless protocols. On occasion, the concurrent receipt and/or transmission using different communication protocols causes interference.

### BRIEF DESCRIPTION OF THE DRAWINGS

The drawings refer to embodiments of the invention in which:

FIG. 1 illustrates a block diagram of an embodiment of a device having an example receiver circuit;

FIG. 2 illustrates a block diagram of an embodiment of a device having an example receiver circuit;

FIG. 3 illustrates a flow diagram of an embodiment for a method of filtering RF signals;

FIG. 4 illustrates a flow diagram of an embodiment for a method of filtering RF signals; and

FIG. 5 illustrates a block diagram of an example system that may use an embodiment of a receiver circuit.

While embodiments of the invention are subject to various modifications and alternative forms, specific embodiments thereof have been shown by way of example in the drawings and will herein be described in detail. Embodiments of the invention should be understood to not be limited to the particular forms disclosed, but on the contrary, embodiments of the intention are to cover all modifications, equivalents, and alternatives falling within the spirit and scope of the invention.

### DETAILED DISCUSSION

In the following description, numerous specific details are set forth, such as examples of specific data signals, named components, connections, number of frequency channels, etc., in order to provide a thorough understanding of embodiments of the present invention. It will be apparent, however, to one of ordinary skill in the art that embodiments of the present invention may be practiced without these specific details. In other instances, well known components or methods have not been described in detail but rather in a block diagram in order to avoid unnecessarily obscuring embodiments of the present invention. Further specific numeric references such as filter logic, may be made. However, the specific numeric reference should not be interpreted as a literal sequential order but rather interpreted to mean that the first filter logic is different than a second filter logic. Thus, the specific details set forth are merely for example. The specific details may be varied from and still be contemplated to be within the spirit and scope of embodiments of the present invention.

In general, a device may include a receiver circuit that has an RF power detector, a suppression filter and a filter logic. The suppression filter may have a band rejection frequency range targeted to suppress interference between a transmitter and a receiver when enabled. The filter logic may enable and disable the suppression filter while the device is in operation based on a signal strength of a received signal. The receiver circuit may further include one or more communication error indicators. The filter logic may also enable and disable the suppression filter based on the signal strength of the received RF signal in combination with the one or more communication error indicators.

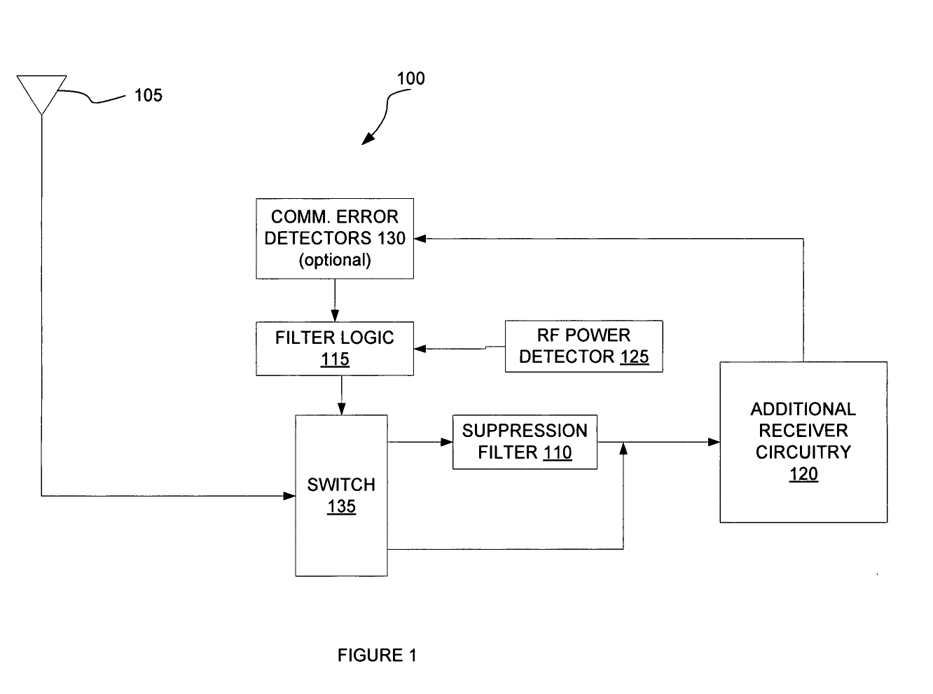

FIG. 1 illustrates a block diagram of an embodiment of a device having an example receiver circuit 100. The receiver circuit 100 includes an antenna 105 to receive RF signals. The antenna 105 may be connected to an input of a switch 135. A filter logic 115 has inputs connected to outputs of one or more communication error detectors 130 and an RF power detector 125, and an output connected to an input of the switch 135. The filter logic 115 actuates the switch 135 to send the received RF signals through the suppression filter 110, or to bypass the suppression filter 110 through a bypass line 140, and send the received RF signals directly to additional receiver circuitry 120. As shown, the bypass line 140 may comprise a received signal communication path that is in parallel to the suppression filter 110.

The additional receiver circuitry 120 may include a demodulator circuit, a low noise amplifier, and/or other receiver circuitry known in the art. In an embodiment, an output of the demodulator circuit (not shown) may be connected to the one or more error detectors 130. In an embodiment, the filter logic 115 may also have an input connected to outputs of a suppression filter 110 and the bypass line 140.

In an embodiment, the received RF signals have frequencies in regulated RF frequency bands. Examples of regulated RF frequency bands include UHF and VHF television broadcast frequencies, AM and FM radio broadcast frequencies and GSM communication frequencies. In an embodiment, the receiver circuit 100 may be a receiver circuit for a mobile computing device such as, for example, a personal data assistant (PDA), notebook, cellular phone, or the like. In an alternative embodiment, the receiver circuit 100 may be a receiver circuit for an electronic device such as a television, radio, desktop computer, etc.

The receiver circuit 100 may be tuned to receive data at specific RF frequency ranges. When the receiver circuit 100 is so tuned, it may pick up RF signals from adjacent RF bands and/or channels. In an embodiment, the suppression filter 110 filters out RF signals from the adjacent RF bands and/or channels that the receiver 100 is not tuned to. In an embodiment, the suppression filter 110 has a band rejection frequency range targeted to suppress interference between a transmitter and the receiver circuit 100 when enabled.

The received signal strength may be the signal strength of an RF signal having a frequency to which the receiver circuit 100 is tuned. The received signal strength may also be the signal strength of RF signals having frequencies in adjacent bands and/or channels. In an embodiment, the suppression filter 110 is enabled merely when RF signals having frequencies in adjacent bands are detected to exceed the threshold signal strength. In an embodiment, the filter logic 115 actuates the switch 135 to enable and disable the suppression filter 110 while the device is in operation based on a signal strength of a received RF signal, as indicated by the RF power detector 125.

In an embodiment, the filter logic 115 enables and disables the suppression filter 110 based on the signal strength of the received RF signal in combination with communication errors indicated by the one or more communication error detectors 130. The one or more communication error detectors 130 may include devices (e.g., circuitry) for the detection of bit error rate, error vector magnitude (EVM), constellation variance, signal to noise ratio, or other types of error detection known in the art. In an embodiment, the one or more communication error detectors are connected to a demodulator circuit (included in the additional circuitry 220). In other embodiments, some or all of the communication error detectors are not connected to the demodulator circuit.

The filter logic 115 may correlate communication errors as reported by these communication error detectors with abnormally large power of RF signals. This correlation may be used to determine whether to actuate the switch 135. In an embodiment, the additional receiver circuitry 120 includes a synchronization circuit (not shown). When the synchronization circuit reports a loss of synchronization, the filter logic 115 may enable the suppression filter 110. In an embodiment, the suppression filter 110 may be enabled when the received RF signals are of sufficient strength to tolerate the filtering and may be disabled when the RF signals are of weak strength and there is no adjacent channel interference.

In an embodiment, once the suppression filter 110 is enabled, it may not be subsequently disabled, even if conditions otherwise indicate that it should be, until a preset time period has passed. Similarly, in an embodiment, once the suppression filter 110 is disabled, it may not be subsequently enabled until a preset time period has passed. This may prevent frequent switching between the bypass line 140 and the suppression filter 110, for example, as a GSM signal hops frequencies and changes time slots.

In an embodiment, the suppression filter 110 may be enabled and disabled rapidly to respond to a changing environment. For example, the suppression filter 110 may be enabled and disabled by the filter logic 115 many times in a second in response to a nearby GSM transmitter hoping to and from one or more frequencies that are close to a frequency band to which the receiver circuit 100 is tuned.

In an embodiment, the filter logic 115 enables the suppression filter 110 when the RF power detector 125 detects a first RF signal having a signal strength above a preset threshold. Enablement of the suppression filter 110 may suppress a power level of the first RF signal. Alternatively, enablement of the suppression filter 110 may suppress one or more other RF signals. In an embodiment, the preset threshold may be a fixed value about a few decibels (dB) below the point at which performance is affected. In an embodiment, the preset threshold may be set to about −20 dBm (decibels referenced to one milliwatt) to about +5 dBm. Alternatively, the threshold may be a dynamic threshold that changes based on operating conditions such as the RF frequency band that the receiver circuit 100 is tuned to, the frequency bands that are being suppressed, user input, operating temperature, and/or other criteria. In an embodiment, the filter logic 115 enables the suppression filter 110 when a second RF signal, to which the receiver circuit 100 is tuned, is detected by the RF power detector 125 as having a sufficient strength to tolerate filtering out adjacent RF frequency bands without suppressing the received RF signal below a minimum detected level by the RF power detector. An example of an adjacent RF frequency band is the first RF signal previously discussed.

Communication errors may occur when adjacent regulated RF frequency band interference is present. In an embodiment, when adjacent RF frequency band interference is present, the filter logic 115 enables the suppression filter 110 to reduce the interference. In an embodiment, the filter logic 115 enables the suppression filter 110 when communication errors exceeding set thresholds are detected. For example. The filter logic 115 may enable the suppression filter 110 when a bit rate error above a set threshold is detected, when a constellation variance above a set threshold is detected, and/or when a signal to noise ratio below a set threshold is detected.

In an embodiment, the suppression filter 110 may be a bandpass filter set at an anticipated RF receiving band. In an embodiment, the suppression filter 110 may be a notch filter, such as a V-notch filter. In an embodiment, the suppression filter 110 may be a notch filter with a suppression of about 10 dB or higher. In other embodiments, the suppression filter may include a low pass filter and/or bandpass filter. In an embodiment, the suppression filter 110 may be configured to suppress RF signals in the UHF frequency range.

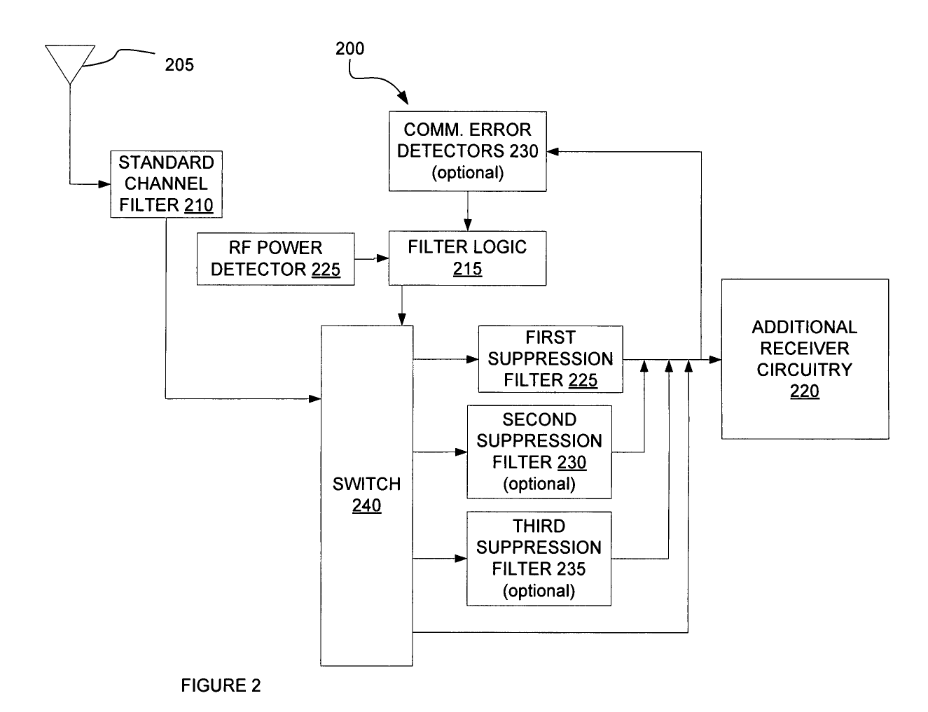

FIG. 2 illustrates a block diagram of an embodiment of a device having an example receiver circuit 200. The receiver circuit 200 includes an antenna 205 to receive RF signals. The antenna 205 may be connected to an input of a standard channel filter 210. The standard channel filter 210 may be one or more channel filters known in the art for attenuating signals out of the band, such as a bandpass filter. These filters accept signals merely in the band of interest and thus are named channel or bandpass filters. The standard channel filter 210 my have a bandpass range targeted to a frequency band for a received RF signal.

An output of the standard channel filter 210 connects to an input of a switch 240. A filter logic 215 has inputs connected to outputs of one or more communication error detectors 230 and an RF power detector 225, and an output connected to an input of the switch 240. The filter logic 215 actuates the switch 240 to send the received RF signals through one or more of a first suppression filter 225, a second suppression filter 230, a third suppression filter 235, or to bypass the suppression filters through a bypass line 240 and send the received RF signals directly to additional receiver circuitry 220.

Each of the first suppression filter 225, second suppression filter 230 and third suppression filter 235 may suppress different regulated RF frequency bands. Though the illustrated embodiment shows three separate suppression filters, more or fewer suppression filters may be used. Alternatively, the different suppression filters may be incorporated into a single variable filter that can be tuned to filter out different regulated RF frequency bands.

The filter logic 215 may actuate the switch 240 to send received RF signals through one of the first suppression filter 225, the second suppression filter 230, the third suppression filter 235 and the bypass line 240. In an embodiment, an output from the suppression filter through which the RF signal is sent (or output from the bypass line 240) may be fed back to an input of the one or more communication error detectors 230. The one or more communication error detectors 230 determine whether communication errors are present in the filtered output. When communication errors are present, the filter logic 215 may actuate the switch 240 to send the RF signals through a different suppression filter, or through the bypass line 240. This process may continue until a signal is fed back to the communication error detector that does not have communication errors, or for which communication errors are minimized. In an embodiment, the filter logic 215 tests each of the suppression filters and the bypass line 240 to determine which produces the most error free signal. Thereby, the filter logic 215 may switch between different filters to achieve optimal performance in different environments.

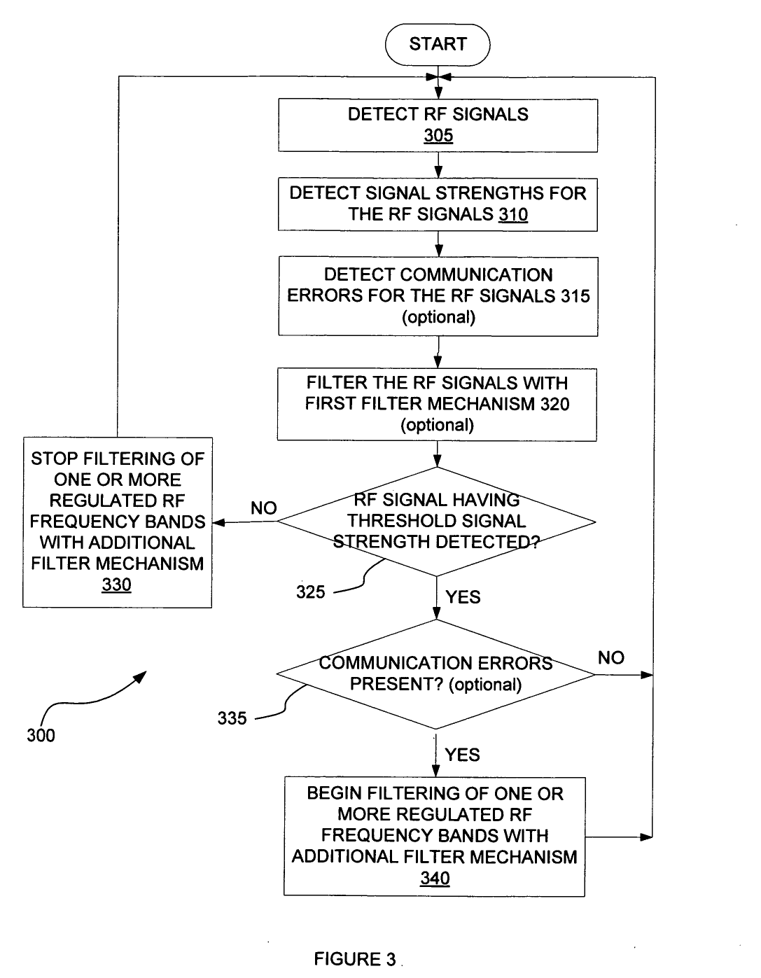

FIG. 3 illustrates a flow diagram for an embodiment for a method 300 of filtering RF signals. The method 300 may be executed by processing logic that may include hard wired circuitry and/or hardware, firmware, software, or a combination thereof. In an embodiment, the method 300 may be executed by the receiver circuit 100 of FIG. 1.

Referring to FIG. 3, the method 300 begins by detecting RF signals (block 305). At block 310, signal strengths for the RF signals are detected. At block 315, communication errors for the RF signals are detected. At block 320, the RF signals are filtered with a first filter mechanism. In an embodiment, the RF signals are filtered after signal strengths and communication errors are detected. In an alternative embodiment, the RF signals are filtered before signal strength and communication errors are detected.

At block 325, processing logic determines whether an RF signal having a threshold signal strength is detected. If at block 325 processing logic determines that no RF signal having at least the threshold signal strength is detected, the process continues to block 330. If an RF signal having the threshold signal strength is detected, the process continues to block 335.

At block 330, processing logic stops the filtering of one or more regulated RF frequency bands with an additional filter mechanism. The process then continues to block 305 to detect RF signals. If at block 330 no additional filter mechanisms are being used to filter one or more regulated RF frequency bands, then block 330 directs processing logic to block 305 without taking further measures.

At block 335, processing logic takes one of two actions, depending on whether or not communication errors are present. When no communication errors are present, the process begins block 305 to continue detecting RF signals. When communication errors are present, processing logic continues to block 340. In an embodiment, processing logic continues to block 340 when a preset threshold of communication errors are present, and proceeds to block 305 when communication errors not exceeding the threshold are detected. At block 340, processing logic begins the filtering of one or more regulated RF frequency bands with an additional filter mechanism, and then directs processing logic to block 305. Filtering with one or more additional filter mechanisms may suppress saturation of a receiver circuit.

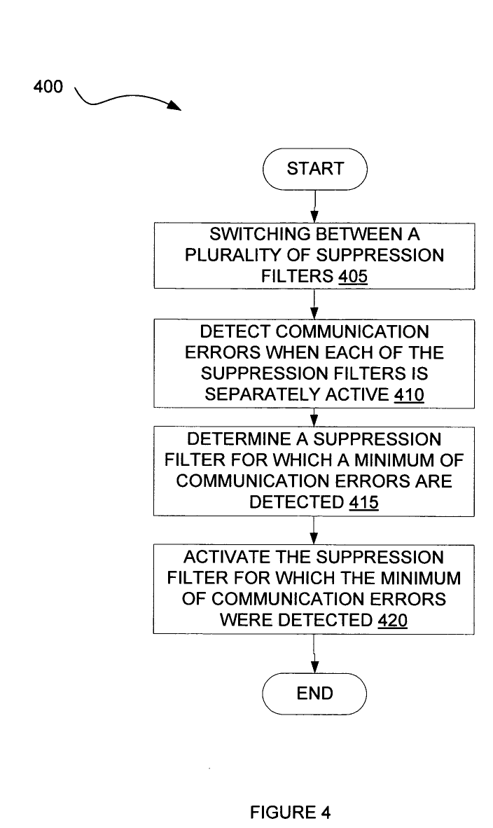

FIG. 4 illustrates a flow diagram of an embodiment for a method 400 of filtering RF signals. In an embodiment, method 400 corresponds to block 340 of FIG. 3. In an embodiment, the method 400 may be executed by the receiver circuit 200 of FIG. 2. Method 400 of FIG. 4 begins by switching between a plurality of suppression filters (block 405). At block 410, processing logic detects communication errors when each of the suppression filters is separately active (enabled). A suppression filter may be active when processing logic has actuated a switch such that RF signals will be received by the suppression filter. In an embodiment, processing logic activates each of the suppression filters in turn to determine a level of communication errors and/or a type of communication errors for that suppression filter.

At block 415, processing logic determines a suppression filter for which a minimum of communication errors are detected. At block 420, the suppression filter for which the minimum of communication errors were detected is activated.

Methods 300 of FIG. 3 and 400 of FIG. 4 may be executed on a mobile computing device. Examples of mobile computing devices include laptop computers, cellular phones, PDAs, or other similar device with on board processing power and wireless communications ability that is powered by a Direct Current (DC) power source, such as a fuel cell or battery.

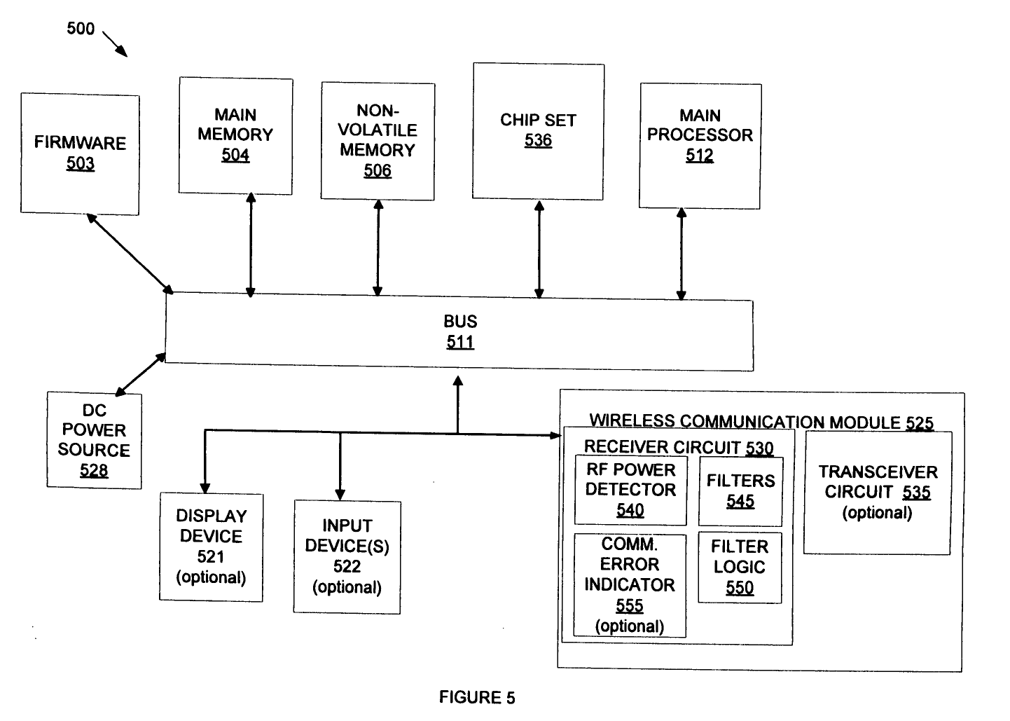

FIG. 5 illustrates a block diagram of an example system 500 that may use an embodiment of the receiver circuit 100 of FIG. 1. In an embodiment, system 500 of FIG. 5 comprises a communication mechanism or bus 511 for communicating information, and an integrated circuit component such as a main processing unit 512 coupled with bus 511 for processing information. One or more of the components or devices in the system 500 such as the main processing unit 512 or a chip set 536 may use data from a receiver circuit 530, which in an embodiment corresponds to the receiver circuit of FIG. 2. Referring to FIG. 5, the one or more components may comprise, for example, a digital TV or other module. The main processing unit 512 may consist of one or more processor cores working together as a unit.

System 500 further comprises a random access memory (RAM) or other dynamic storage device 504 (referred to as main memory) coupled to bus 511 for storing information and instructions to be executed by main processing unit 512. Main memory 504 also may be used for storing temporary variables or other intermediate information during execution of instructions by main processing unit 512.

Firmware 503 may be a combination of software and hardware, such as Electronically Programmable Read-Only Memory (EPROM) that has the operations for the routine recorded on the EPROM. The firmware 503 may embed foundation code, basic input/output system code (BIOS), or other similar code. The firmware 503 may make it possible for the system 500 to boot itself.

System 500 also comprises a read-only memory (ROM) and/or other static storage device 506 coupled to bus 511 for storing static information and instructions for main processing unit 512. The static storage device 506 may store OS level and application level software.

System 500 may further be coupled to or have an integral display device 521, such as a cathode ray tube (CRT) or liquid crystal display (LCD), coupled to bus 511 for displaying information to a computer user. A chipset may interface with the display device 521.

System 500 may include one or more input devices 533 coupled to bus 511 for communicating information and command selections to main processing unit 512. Examples of input devices 522 include an alphanumeric input device such as a keyboard, a cursor control device (e.g., a mouse, trackball, trackpad, stylus, or cursor direction keys), and a joystick.

Another device that may be coupled to bus 511 is a DC power source (e.g., a power supply, battery, and/or Alternating Current adapter circuit). A wireless communication module 525 may be coupled to bus 511. The wireless communication module 525 may employ a Wireless Application Protocol to establish a wireless communication channel. The wireless communication module 425 may implement a wireless networking standard such as Institute of Electrical and Electronics Engineers (IEEE) 802.11 standard, IEEE std. 802.11-1999, published by IEEE in 1999.

The wireless communication module 525 may include one or more receiver circuit 530 and/or transceiver circuit 535. The receiver circuit 530 may include an RF power detector 540, a communication error detector 555, filters 545 and a filter logic 550. The receiver circuit 530 may be configured to minimize interference between a tuned RF band and adjacent RF bands such as regulated RF bands. In an embodiment, the wireless communication module 525 is a digital TV module.

Where a transceiver circuit 535 and receiver circuit 530 are both present in the wireless communication module 525, the receiver circuit 530 may receive signals from the transceiver circuit indicating that a transmission is imminent. The receiver circuit may respond to this communication by enabling an appropriate one of the filters 545 (e.g., a suppression filter).

In an embodiment, the software used to facilitate routines executed on the bus 511, chip set 536, main processor 512, and/or other connected module or device can be embedded onto a machine-readable medium. A machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM) including firmware; random access memory (RAM); magnetic disk storage media; optical storage media; flash memory devices; etc.); etc.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

In an embodiment, the logic consists of electronic circuits that follow the rules of Boolean Logic, software that contain patterns of instructions, or any combination of both.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but merely by scope of the appended claims.

What is claimed is:

1. A device, comprising:
an RF power detector;
a suppression filter having a band rejection frequency range to suppress interference between a transmitter and a receiver circuit when enabled; and
a filter logic to enable and disable the suppression filter while the device is in operation based on a signal strength of a received RF signal.

2. The device of claim 1, further including:
the receiver circuit further includes a communication error detector, and
the filter logic is configured to enable and disable the suppression filter based on the signal strength of the received RF signal in combination with one or more communication errors indicated by the communication error detector.

3. The device of claim 2, wherein the receiver circuit further includes a standard channel filter having a bandpass range targeted to a frequency band for the received RF signal, and additional suppression filters, wherein the suppression filter and each of the additional suppression filters suppress different regulated RF frequency bands; and the filter logic is further configured to switch between the standard channel filter, the suppression filter and the additional suppression filters based on the signal strength of the received RF signal in combination with the one or more communication errors indicated by the communication error detector.

4. The device of claim 2, wherein the filter logic is configured to enable the suppression filter when interference from an adjacent regulated RF frequency band to the frequency band for the received RF signal is present, wherein the adjacent regulated RF frequency band interference is identified by the communication error detector.

5. The device of claim 1, wherein the receiver circuit has a received signal communication path with a switch that can be activated in order to bypass the suppression filter, wherein the received signal communication path is in parallel to the suppression filter and the filter logic couples to the switch.

6. The device of claim 1, wherein the filter logic is further configured to enable the suppression filter when the RF power detector detects a first RF signal having a signal strength above a preset threshold, wherein the suppression filter suppresses a power level of the first RF signal.

7. The device of claim 6, wherein the filter logic is further configured to enable the suppression filter when a second RF signal detected by the signal detector is of sufficient strength to tolerate filtering out adjacent RF frequency bands without suppressing the received RF signal below a minimum detected level by the RF power detector, the second RF signal having a frequency band that is adjacent to a frequency band of the first RF signal.

8. The device of claim 7, further comprising:
at least one communication error detector having logic to identify whether the second RF signal is of sufficient strength to tolerate filtering out adjacent RF frequency bands.

9. The device of claim 1, wherein the suppression filter is a notch filter with a power level suppression equal to or higher than 10 dB.

10. A method, comprising:
detecting RF signals received in a portable device powered by a direct current power source;
detecting signal strengths for the RF signals;
filtering the RF signals with a first filter mechanism;
beginning filtering of one or more regulated RF frequency bands with an additional filter mechanism when a first RF signal from the detected RF signals having at least a threshold signal strength is detected; and
stopping filtering of the one or more regulated RF frequency bands with the additional filter mechanism when no RF signal having at least the threshold signal strength is detected.

11. The method of claim 10, further comprising:
suppressing a saturation of a receiver circuit when filtering the one or more regulated RF frequency bands with the additional filter mechanism.

12. The method of claim 10, further comprising:
detecting communication errors from the group consisting of a bit rate error above a set threshold, a constellation variance above a set threshold, and a signal to noise ratio below a set threshold; and
beginning filtering of the one or more regulated RF frequency bands when the RF signal having at least the threshold signal strength is detected and when communication errors are present.

13. The method of claim 10, wherein:
the additional filter mechanism includes at least one suppression filter.

14. The method of claim 13, wherein the at least one suppression filter includes a plurality of suppression filters, comprising:
switching between the plurality of suppression filters;
detecting communication errors when each of the suppression filters is separately active; and
determining a suppression filter for which a minimum of communication errors are detected.

15. A system, comprising:
a receiver circuit, having an RF power detector, a suppression filter having a band rejection frequency range targeted to suppress interference between a transmitter and the receiver circuit when enabled, and a filter logic to enable and disable the suppression filter while the device is in operation based on a signal strength of a received RF signal; and
a DC power source, that powers the RF power detector, the suppression filter, and the filter logic.

16. The system of claim 15, further including:
the receiver circuit further includes a communication error detector, and
the filter logic is configured to enable and disable the suppression filter based on the signal strength of the received RF signal in combination with one or more communication errors detected by the communication error detector.

17. The system of claim 16, wherein the receiver circuit further includes a standard channel filter having a bandpass range targeted to a frequency band for the received RF signal, and additional suppression filters, wherein the suppression filter and each of the additional suppression filters suppress different regulated RF frequency bands; and the filter logic is further configured to switch between the standard channel filter, the suppression filter and the additional suppression filters based on the signal strength of the received RF signal in combination with the one or more communication errors detected by the communication error detector.

18. The system of claim 15, further comprising:
a transceiver circuit that transmits additional regulated RF frequency signals; and
the suppression filter further configured to suppress interference caused by the additional regulated RF frequency signals.

19. The system of claim 15, wherein:
the receiver circuit has a received signal communication path with a switch that can be activated in order to bypass the suppression filter, wherein the received signal communication path is in parallel to the suppression filter and the filter logic couples to the switch.

20. The system of claim 15, further comprising:
a digital TV module that includes the receiver circuit.
